(19) United States
(12) Patent Application Publication
(10) Pub. No.: US 2002/0082985 A1
(43) Pub. Date: Jun. 27, 2002

(54) Method and system for converting existing or future trade credit obligations into a new obligation

(76) Inventor: J. Sott MacKay, Randolph, NJ (US)

Correspondence Address: Patrick J. Farley, WOODCOCK WASHBURN KURTZ, MACKIEWICZ & NORRIS LLP, One Liberty Place-46th Floor, Philadelphia, PA, 19103, US

(21) Appl. No.: 09/742,024

(22) Filed: Dec. 21, 2000

(51) Int. Cl. G06F 17/60

(52) U.S. Cl. 705/39

(57) ABSTRACT

The invention relates to a method and system wherein a Funding Company and a Purchaser enter into an agreement pursuant to which a mechanism is established under which the Purchaser's Suppliers are offered the opportunity to obtain the prompt or accelerated payment of the Purchaser's existing or future trade credit obligations (which are commonly referred to as the Purchaser's “accounts payable” or “trade payables”) to them in exchange for providing percentage discounts, which are commonly referred to as “prompt payment discounts,” from such trade credit obligations. Suppliers may bargain or bid for prompt or accelerated payment under the mechanism that is established by offering prompt payment discounts with respect to such trade credit obligations. The Funding Company pays the discounted price of the trade credit obligation on behalf of the Purchaser, and the Purchaser pays the Funding Company a higher amount than the discounted price of such trade credit obligation, up to the full face value of such trade credit obligation, at an agreed upon future date.

### BACKGROUND OF THE INVENTION

1. Field of the Invention

The invention relates to a method and system for processing a Purchaser's existing or future trade credit obligations (which are commonly referred to as “accounts payable” or “trade payables”) in a manner that (i) converts such existing or future trade credit obligations into a new obligation, and (ii) provides financial and other benefits to a Purchaser. More specifically, the invention relates to a business method and associated system wherein a Funding Company and a Purchaser enter into an agreement pursuant to which a mechanism is established under which the Purchaser's Suppliers are offered the opportunity to obtain the prompt or accelerated payment of the Purchaser's existing or future trade credit obligations to them in exchange for providing percentage discounts, which are commonly referred to as “prompt payment discounts,” from such trade credit obligations. Suppliers may bargain or bid for prompt or accelerated payment under the mechanism that is established by offering prompt payment discounts with respect to such trade credit obligations. Pursuant to the Agreement, the Funding Company pays the discounted price of the trade credit obligation on behalf of the Purchaser, and the Purchaser pays the Funding Company a higher amount than the discounted price of such trade credit obligation, up to the full face value of such trade credit obligation, at an agreed upon future date.

2. Background of the Related Art

Trade credit is a large and vital part of the United States economy. In fact, a number of studies have classified trade credit as “the single most important source of short-term external finance in the United States.” See Petersen, M. and R. Rajan, 1997, “Trade Credit: Theories and Evidence,” The Review of Financial Studies, 10, 661-691. Each year, companies utilize trade credit to purchase trillions of dollars of goods and services “on account.” According to statistical release Z.1 published by the Federal Reserve and dated Sep. 15, 2000, businesses in the United States had approximately $1.3 trillion of accounts payable outstanding at the end of the second quarter of 2000.

The accounts payable of credit-worthy companies generated through the extension of trade credit serve as the basis of the accounts receivable segment of the asset-based lending industry. According to recently published statistics from the Commercial Finance Association, non-bank financial institutions that engage in factoring and which provide asset based loans and lending facilities, which are known as “Commercial Finance Companies,” provide trillions of dollars of advances each year to companies that do not use or which do not qualify for traditional bank financing. Commercial Finance Companies make these advances by, among other methods, purchasing or lending against a company's qualified “accounts receivable.” These qualified accounts receivable are, of course, the same “accounts” that are classified as accounts payable by credit-worthy businesses that have purchased goods or services on trade credit. In fact, Commercial Finance Companies frequently market their services to companies that cannot obtain credit based on their own financial strength as a means for them to obtain the financing that they need by leveraging the credit strength of their customers.

Factoring and other accounts receivable based finding programs often are expensive methods of financing a business. The cost of funds from a Commercial Finance Company, once all service fees, discount fees, and interest charges are totaled, typically will range from 18% per annum for the best clients, to nearly 50% per annum for the riskiest clients. The advance rates of Commercial Finance Companies typically will range from 60% of qualified accounts receivable to 85% of qualified accounts receivable with better established and more financially secure companies receiving higher advance rates. A Commercial Finance Company typically will provide an advance rate of approximately 75%.

Receivables based financing is an inequitable and inefficient method of leveraging the financial assets generated by credit worthy companies that make purchases on account through the extension of trade credit. This method of finance is inequitable because it utilizes the financial strength and credit quality of companies that purchase goods or services on account without providing them with any compensation. Put simply, receivables based financing is a means for Suppliers and Commercial Finance Companies to enter into financing relationships that are premised on value that exists because of the financial strength of companies that purchase goods and services on account.

Receivables-based financing is also a very inefficient form of finance from both an operational and a financial perspective. In every receivables based financing relationship, Commercial Finance Companies need to run searches and perform verifications to confirm the ownership, existence, credit quality, and validity of the “accounts” against which they are being asked to advance funds by their clients. These searches and verifications are time consuming and can be quite costly. In fact, there are entire industries that exist in order to assist Commercial Finance Companies in searching, analyzing, monitoring, and processing the accounts receivable of companies that are financed under accounts receivable based programs.

From a financing perspective, factoring and other receivables-based funding programs are also inefficient because they do not allow Commercial Finance Companies to easily or proactively purchase or finance a balanced and diversified portfolio of quality trade credit accounts. Instead, Commercial Finance Companies must purchase or finance the accounts receivable that are generated by their clients and then attempt to balance and diversify the portfolio of accounts that is created.

The business system described in U.S. Pat. No. 5,694,552 to Ahroni represents an improved method of implementing an accounts receivable based financing program for a Supplier. That business system transforms a Supplier's factoring or sale of an account receivable to a Commercial Finance Company under a factoring contract into a Supplier's sale of a trade acceptance draft (“TAD”) to a financial Organization under a TAD Participation Agreement. The system described in that patent doesso through the use of a TAD which (i) is a negotiable financial instrument that must serve as the means of payment from a Purchaser to a Supplier in a specific transaction, and (ii) must be generated by a Supplier, accepted and endorsed by a Purchaser, accepted by the Supplier as payment in that specific transaction, and then sold by the Supplier to a Financial Organization.

The business system described in U.S. Pat. No. 5,694,552 to Ahroni does not, however, disclose a method of trade credit finance that is not designed to finance an asset of a Supplier and which does not require or involve the sale of an account receivable, financial instrument, or other asset by a Supplier to a third party. The business system described in that patent requires the sale of a TAD, which is a negotiable financial instrument that has been created to replace an account receivable in a specific transaction, by a Supplier to a third party. Moreover, the system described in that patent does not disclose a method of trade credit finance that can be implemented by or on behalf of a Purchaser. That system must be implemented by a Supplier which must (i) generate a TAD and obtain the endorsement of the Purchaser on such TAD, and (ii) sell the TAD to a third party. In addition, the system described in that patent does not offer a means for a Purchaser to generate revenue from the processing of its existing or future trade credit obligations.

Thus, it is desirable to have a method of trade credit finance that (i) is not designed to finance an asset of a Supplier and which does not require a Supplier to sell an account receivable, financial instrument, or other asset to a third party, and (ii) a Purchaser can establish and utilize to process one or more of its existing or future trade credit obligations in a manner that converts it or them into a new financial obligation through a method that provides the Purchaser with financial and other benefits and which therefore enables the Purchaser to benefit from its own credit strength as an account debtor in its trade credit transactions. The present invention has been developed to address these needs in the art.

### SUMMARY OF THE INVENTION

The Accounts Payable System (“AP System”) and method of the invention is an innovative financial engineering process that has been designed to eliminate the inequities and the operational and financial inefficiencies of the existing methods of trade credit finance. It is a two party system based upon a contractual relationship between the Funding Company and a Purchaser pursuant to which (i) a Purchaser's existing or future trade credit obligations, which are commonly referred to as “accounts payable” or “trade payables” are consolidated, processed, and converted into a new financial obligation, preferably one that is an absolute and unconditional short-term payment obligation of the Purchaser, and (ii) the Purchaser transfers that new financial obligation to the Funding Company. The Funding Company may finance such short-term payment obligation through the issuance of short-term commercial paper or through other methods. In certain embodiments of the invention, a Funding Company packages this new financial asset with similar financial assets from one or more other Purchasers, and then finances its diversified portfolio of short-term financial obligations of companies with strong credit ratings through the issuance of short-term commercial paper at attractive interest rates.

The Purchaser's existing and future trade credit obligations may be consolidated and converted into a new financial obligation in the following way: the Funding Company may provide a mechanism whereby at least one Supplier can bid for the prompt or accelerated payment of at least one of its existing accounts receivable from a Purchaser (which corresponds to an “account payable” of the Purchaser), or of one of its purchase orders from, or invoices to, a Purchaser, by offering a prompt payment discount (a “PPD”). The Supplier agrees to accept a prompt or accelerated (preferably immediate or immediately upon confirmation of performance) payment, reflecting the PPD, in satisfaction of the amount owed under the account receivable or the amount that will be owed for the product or service to be supplied to the Purchaser under such purchase order or invoice. Based on the agreement between the Purchaser and the Funding Company, the Funding Company agrees to pay the discounted amount owed to the Supplier in exchange for an obligation of the Purchaser to pay the Funding Company an amount greater than the discounted amount, up to the full face value of the original amount due to the Supplier under the account payable (which corresponds to the “account receivable” of the Supplier) or under the purchase order or invoice, at an agreed upon time or pursuant to an agreed upon payment schedule.

In a specific embodiment of the invention, the Funding Company may establish a computerized, web-based auction system under which Suppliers that have been selected by a Purchaser are able to bid for the prompt or accelerated payment of their existing accounts receivable (which correspond to existing accounts payable of the Purchaser) or their purchase orders from, or invoices to, the Purchaser by offering prompt payment discounts (a “PPD Auction”). By bidding in a PPD Auction, a Supplier agrees to accept a prompt or accelerated (preferably immediate or immediately upon confirmation of performance) payment of the amount of its accounts receivable or of its purchase order or invoice minus the prompt payment discount that it has bid (the “Discounted Payment Amount”) as payment in full for such account receivable or for the product or service covered by such purchase order or invoice. Based on its agreement with the Purchaser, the Funding Company will accept a certain dollar volume of bids from the Purchaser's Suppliers that meet or exceed an agreed upon minimum discount. Upon (i) the close of a PPD Auction, and (ii) in the case of future trade credit obligations arising under purchase orders or invoices that relate to pending or open orders, receipt of confirmation from the Purchaser that a Supplier has delivered its goods or performed its services, the Funding Company makes a prompt or accelerated payment on the Purchaser's behalf directly to each of the winning bidders in an amount equal to such bidder's Discounted Payment Amount as payment in full of the account receivable or of the purchase order or invoice of such bidder that was included in the PPD Auction.

In a preferred embodiment, the Purchaser may initiate a wire transfer or some other electronic transfer of funds to the Funding Company in an amount up to the full face amount of the accounts payable (which correspond to the “accounts receivable” of the Suppliers) or of the purchase orders or invoices that were satisfied following the PPD Auction, that is scheduled to occur on a date that is an agreed upon number of days from the date on which the Funding Company made payment or began making payments to the Purchaser's Suppliers (a “Deferred Payment Authorization”). Thus, the AP System converts many existing or future trade credit obligations (accounts payable or trade payables) of the Purchaser into one Deferred Payment Authorization that is a payment obligation of the Purchaser to pay a specified amount on a date certain.

Once the Purchaser generates a Deferred Payment Authorization, the Funding Company accepts this financial obligation as payment in full for the Funding Company's payment of Purchaser's trade credit obligations and thus acquires a financial asset that is preferably an absolute and unconditional obligation of the Purchaser to pay the Funding Company a specified amount on a future date.

The invention also provides a method and system wherein the Purchaser serves as the Funding Company. In a preferred embodiment, the Purchaser enters into an agreement with at least one Supplier to accept a discounted amount with respect to an account payable of the Purchaser in exchange for the accelerated payment of the discounted amount as determined by an auction, wherein at least one of the Suppliers bids a percentage discount with respect to an account payable of the Purchaser owing or to become owing to the Supplier for the accelerated payment of the account payable. Bids that are accepted in accordance with the requirements and specifications of the auction determine the discounted amount of the account payable. The Purchaser transfers to the Supplier an amount to satisfy payment of the discounted amount and finances the payment to the Supplier of the discounted amount.

### BRIEF DESCRIPTION OF THE FIGURES

The above and other beneficial features of the invention will be apparent from the following detailed description in connection with the attached figure, of which:

FIG. 1 shows a diagram of an embodiment of the method of converting existing or future trade credit obligations into a new obligation in accordance with the invention.

FIG. 2 shows a diagram of an embodiment of the method of converting an existing or future trade credit obligation into a new obligation in accordance with the invention, with the Purchaser serving as the Funding Company.

### DETAILED DESCRIPTION OF THE INVENTION

Definitions:

As used herein, the term “Account Payable” means an existing or future trade credit obligation of a Purchaser that is owing or will become owing, and shall include, but not be limited to, any (i) obligation of a Purchaser to pay for goods or services that have been obtained from a Supplier, and (ii) potential obligation of a Purchaser that is scheduled or intended to arise in the future as a result of, or in connection with, a pending or open order or other transaction in which a Supplier has offered or agreed to provide a Purchaser with goods or services “on account” through the extension of trade credit.

As used herein, the term “AP System” is the Accounts Payable System of the invention in which one or more Accounts Payable are consolidated, processed, and converted into a new obligation.

As used herein, the term “Purchaser” refers to an entity that obtains trade credit and purchases goods or services on account. Any entity that buys goods and services on account through the use of trade credit including, but not limited to, domestic companies, foreign companies, local, state, and national or federal governments, both domestic and foreign, and any agency or instrumentality of any government, can be a Purchaser under the AP System. Preferably, the Purchaser is an entity that has a strong credit rating and which engages in a high volume of trade credit transactions.

As used herein, the term “Funding Company” refers to a party to the AP System Contract with a Purchaser to implement the AP System for that Purchaser. A Funding Company can be, for example, an entity that is formed by a financial institution to be a subsidiary or affiliate with the sole or special purpose of serving as a Funding Company under AP System Contracts with one or more Purchasers; an entity that is formed by a Purchaser to be a subsidiary or affiliate with the sole or special purpose of serving as a Funding Company under an AP System Contract with that Purchaser; an investment bank, commercial bank, insurance company, or other financial institution; or any other entity of any type or structure.

As used herein, the term “AP System Contract” refers to a contract between a Purchaser and a Funding Company under which a portion of the Accounts Payable of a Purchaser are consolidated, processed, and converted into an entirely new financial asset that can be efficiently and effectively financed by the Funding Company. An AP System Contract establishes the manner in which the various elements of the AP System will be structured by a Purchaser and a Funding Company. An AP System Contract may be structured to meet the unique needs of a Purchaser and its Suppliers and, therefore, is not limited to specific details. Generally, the AP System Contract will preferably address such items as: the economic benefits that will be provided to the Purchaser from the AP System which typically will include extended payment terms for the Purchaser for the obligations represented by the Invoices included in each Supplier Pool, and payment to the Purchaser of a percentage of the prompt payment discounts provided by Suppliers with respect to such Invoices; minimum and maximum amounts for the volume of Accounts Payable to be processed through the AP System each year; an aggregate limit for the Deferred Payment Authorizations that can be outstanding from the Purchaser to the Funding Company at any one time; the means or method that will be utilized to create Supplier Pools; the means or method that will be used to process and pay at a discount the Invoices from each Supplier Pool; the means or method that a Purchaser will utilize to generate Deferred Payment Authorizations; and the terms under which the Funding Company will accept Deferred Payment Authorizations as payment for the Funding Company's satisfaction of the Invoices on behalf of the Purchaser.

As used herein, the term “Supplier” refers to an entity that provides a good or service to a Purchaser.

As used herein, the term “Supplier Pool” refers to a group of Suppliers that provide goods and/or services to a Purchaser or Purchasers. A variety of means or methods can be used to create a Supplier Pool, both separately and in combination with one another, under the AP System, including, but not limited to, an auction conducted by a Funding Company by phone, fax, or electronic means (e.g., an Internet web site) under which Suppliers bid prompt payment discounts for the immediate discounted payment of their Invoices to a Purchaser; an auction conducted by a Purchaser by phone, fax, or electronic means, including, but not limited to, the use of an Internet web site, under which Suppliers bid prompt payment discounts for the immediate discounted payment of their Invoices to a Purchaser; negotiations or discussions between a Purchaser and its Suppliers; negotiations or discussions between a Funding Company and a Purchaser's Suppliers; agreements between a Purchaser and its Suppliers under which such Suppliers agree that they will provide specified prompt payment discounts for the accelerated payment of their Invoices; and agreements between a Funding Company and a Purchaser's Suppliers under which such Suppliers agree that they will provide specified prompt payment discounts for the accelerated payment of their Invoices to the Purchaser.

As used herein, the term “Invoice” shall mean any invoice, order, purchase order, or other documentation or evidence of any type or kind, whether printed, electronic, or stored in any media or format of any type or kind, that evidences or relates to an Account Payable.

As used herein, the term “Deferred Payment Authorization” refers to a means or method for the Purchaser to provide the Funding Company with an obligation to pay up to the full face amount of the Invoice or Invoices that were satisfied by the Funding Company on the Purchaser's behalf at a discount that will occur on a specific date.

As used herein “accelerated payment” refers to payment to a Supplier that is made more promptly than would normally occur under the payment terms between a Purchaser and a Supplier, and includes, but is not limited to immediate payment, prompt payment, and payment on an expedited basis.

As used herein “existing or self-generated funds” refers to money or assets controlled by the Purchaser or Funding Company and includes, but is not limited to, money or assets generated through operations, short or long-term debt, or the issuance or sale of stock or other securities.

As used herein, the term “electronic medium” refers to an electronically operating device to send and receive information. Non-limiting examples include telephone, facsimile, and a computer network.

Description of the AP System:

The AP System is based upon an agreement between a Funding Company and at least one Purchaser with at least one Account Payable, and in which the Account Payable or Accounts Payable are consolidated and converted into a new obligation. Typically a Purchaser will have a plurality of Accounts Payable which are processed and converted into one obligation of the Purchaser which is payable to the Funding Company as a Deferred Payment Authorization of the Purchaser to the Funding Company.

An AP System Contract establishes the terms and conditions under which Deferred Payment Authorizations will be created by a Purchaser and conveyed to the Funding Company. The Funding Company and/or Purchaser will structure each AP System Contract to meet the unique needs of each Purchaser and its Suppliers. Accordingly, no two AP System Contracts must be identical. Each AP System Contract, however, will preferably contain provisions that address the following issues:

Length of Extended Payment Terms: The Purchaser may receive extended payment terms for its Accounts Payable. Typically, the term of extended payment will range from about 30 to 60 days beyond due date for payment of such Accounts Payable as set forth in the Invoices with respect to such Accounts Payable.

Percentage of Prompt Payment Discounts: The Purchaser may receive a percentage of the prompt payment discounts that the Funding Company obtains from Suppliers through each PPD Auction. Each AP System Contract will establish both the percentage of this discount that is shared and the timing of revenue sharing payments to the Purchaser. In embodiments in which the Purchaser receives a percentage of the prompt payment discount, the Purchaser may (a) receive a percentage that increases on a sliding scale basis as the amount of the prompt payment discount increases, and (b) be paid its percentage of the prompt payment discounts at predetermined times during the year. In addition, in an AP System Contract offering the Purchaser a percentage of the prompt payment discount, the AP System Contract will preferably provide that a Purchaser will forfeit its accrued percentage payment if the Purchaser does not make a payment under a Deferred Payment Authorization on time or otherwise defaults under its obligations to the Funding Company.

Amount of Deferred Payment Authorizations that may be Outstanding: Preferably, the Funding Company and the Purchaser will agree on the maximum amount of Deferred Payment Authorizations that may be outstanding from the Purchaser to the Funding Company at any one time.

Amount of Accounts Payable to be Financed: Preferably, the Funding Company and Purchaser will agree on the minimum and the maximum amount of Accounts Payable that will be processed through the AP System each year.

Terms of the PPD Auction: For embodiments in which a PPD Auction is employed, the Funding Company and the Purchaser will agree on guidelines for PPD Auctions of the Purchaser's Suppliers that will address issues such as the manner in which the Purchaser will select the Suppliers that will be allowed to participate in each PPD Auction, the minimum and maximum amount of the bids from each PPD Auction that will be accepted by the Funding Company, and the minimum acceptable bid terms for each PPD Auction.

Terms of Deferred Payment Authorizations: Preferably, the Purchaser will agree to issue Deferred Payment Authorizations to the Funding Company that will be pre-authorized electronic transfers of funds that will be absolute and unconditional payment obligations of the Purchaser. The Purchaser will preferably retain its right to make claims against Suppliers concerning defects in the goods or services such Suppliers provided. Preferably, the Purchaser will not have the right to use any such disputes or claims as a basis to avoid or defer a payment to the Funding Company.

Purchase and Sale of Deferred Payment Authorizations: Preferably, the Funding Company will agree to accept Deferred Payment Authorizations from the Purchaser as payment in full for the Funding Company's satisfaction of the Purchaser's Accounts Payable through the Funding Company's payment to Purchaser's Suppliers that were winning bidders pursuant to a PPD Auction.

The new financial asset under the AP System is a payment obligation of the Purchaser to the Funding Company. Preferably, the payment obligation is an absolute and unconditional short-term payment obligation. The Funding Company satisfies the Account(s) Payable of the Purchaser at a discount, and finances an amount equal to the discounted payment(s) to the Purchaser's Supplier(s), for example, through the issuance of short-term commercial paper that is backed or secured by the Purchaser's Deferred Payment Authorization, preferably at an attractive interest rate. Of course, other methods of financing the payments that are made to a Purchaser's Suppliers under the AP System through the use of Deferred Payment Authorizations are available, including, but not limited to, selling one or more Deferred Payment Authorizations at a discount or obtaining a loan that is secured by one or more Deferred Payment Authorizations.

In certain embodiments of the invention, the Funding Company packages this new financial asset that it has acquired with Deferred Payment Authorizations from one or more other Purchasers, and then finances its diversified portfolio of short-term financial obligations of companies with strong credit ratings through the issuance of short-term commercial paper at attractive interest rates. For instance, a Purchaser may have Accounts Payable with respect to many different Suppliers which may be consolidated into a single obligation to the Funding Company. The Funding Company may perform this function for several Purchasers, thereby acquiring a portfolio of Deferred Payment Authorizations from a number of Purchasers with strong credit ratings, which the Funding Company may effectively finance in a variety of ways, including, but not limited to, through the issuance of short-term commercial paper at low interest rates (due to the credit strength of the Purchasers that have issued the Deferred Payment Authorizations that are in the Funding Company's portfolio).

In the AP System, a Supplier or Suppliers are provided with a mechanism to offer PPDs with respect to at least one of the Supplier's Invoices to a Purchaser. The mechanism provided to the Supplier(s) is not particularly limited. For example, the Funding Company or Purchaser may meet with a Supplier to negotiate a PPD. The negotiation may be in person, or may be communicated via an electronic medium, such as, but not limited to, over the telephone, via facsimile, or electronic mail, over the Internet, or any other means to communicate information. In a preferred embodiment, an electronic medium is used by the Purchaser and Supplier to communicate PPD bids or offers. Most preferably, the electronic medium is a web-based auction system, described in more detail below.

In certain embodiments, the Purchaser or Funding Company establishes a mechanism to enable more than one Supplier to offer or bid PPDs. In such an embodiment, the Suppliers may offer PPDs as bids that may be accepted or rejected by the Purchaser or the Funding Company. The bidding may take place such that a given Supplier is without knowledge of other Supplier's bids, or the bidding may take place wherein the Suppliers are privy to each other's bids.

Bidding systems through which a PPD Auction is implemented may be established by the Purchaser or by the Funding Company on behalf of the Purchaser.

The web-based auction may be structured in a variety of ways depending on the nature of the relationship between a Purchaser and its Suppliers, the volume of Accounts Payable that the Purchaser would like to process through the AP System, the amount of prompt payment discount desired or required by the Purchaser, for example. The auctions may be offered at various times during a year depending on the needs of the Suppliers and Purchasers, and may be influenced by such factors as the amount of PPDs that can be obtained versus the interest rates available for short-term commercial paper.

Those of skill in the art may easily determine the best times to offer auctions, how often to conduct auctions, and how the auctions are to be structured. In some embodiments, the Purchaser will set a minimum amount of a prompt payment discount that will be accepted. For example, but not by way of limitation, a Purchaser or Funding Company may set an amount of 3% as a threshold. Suppliers that bid a percentage discount from their Invoices of 3% or more have submitted acceptable bids. Suppliers bidding less than a percentage discount from their invoices of less than 3% have submitted bids that will be rejected. In other embodiments, the Purchaser or Funding Company may have a limit for the total dollar amount of Accounts Payable that it would like to process through the AP System in any one PPD Auction. In this scenario, if the total dollar volume of the Accounts Payable for which bids that exceed the required minimum discount have been entered exceeds the limit that has been established, then bids will be accepted in descending order until the required limit is reached. Ties between or among bids may be resolved through a variety of methods including, but not limited to, allowing the bid that was entered first to prevail over a subsequent bid or bids. The structure of the auction may take into account some or all of these factors. Those of ordinary skill in the art, based on the disclosure of the concepts herein, would easily be able to structure auctions to suit the need of the Purchasers under various circumstances.

In a preferred embodiment of the invention, the Funding Company establishes a computerized, web-based auction system under which Suppliers that have been selected by a Purchaser are able to bid for the prompt or accelerated payment of their Invoices by offering prompt payment discounts (a “PPD Auction”). In addition, the Purchaser may select specific Invoices of the Suppliers that are to be included in the PPD Auction. In some embodiments of the invention, by bidding in a PPD Auction, a Supplier agrees to accept a prompt or accelerated payment of the amount of its Invoice minus the prompt payment discount that it has bid (the “Discounted Payment Amount”) as payment in full for the product or service covered by such Invoice. In other embodiments of the invention, by bidding in an auction, the Supplier may agree to accept a prompt or accelerated payment of the amount of its Invoice minus the prompt payment discount that it has bid on an agreed upon payment schedule (e.g. 2% net 10). Based on its agreement with the Purchaser, the Funding Company will accept a certain dollar volume of bids from the Purchaser's Suppliers that meet or exceed an agreed upon minimum discount. Upon (i) the close of a PPD Auction, and (ii) in the case of future trade credit obligations arising under Invoices for pending or open orders, receipt of confirmation from the Purchaser that a Supplier has delivered its goods or performed its services, the Funding Company makes apayment at the agreed upon time (e.g., immediately or according to an agreed upon future date certain) on the Purchaser's behalf directly to each of the winning bidders in an amount equal to such bidder's Discounted Payment Amount as payment in full of the Invoice of such bidder that was included in the PPD Auction.

A Purchaser may control which of its Suppliers are permitted to bid in a PPD Auction. Through such a structure, a Purchaser may maintain control over its Suppliers and is able to exclude from the PPD Auction any Supplier that cannot demonstrate, through performance history or financial wherewithal, the capability to stand behind a defective product or service after it has been paid in full. Once a Purchaser has selected the Suppliers that will participate in a particular PPD Auction, each eligible Supplier may be invited to bid with respect to the Invoice that the Purchaser has elected to include in the PPD Auction.

In a preferred embodiment, a Computerized Auction System may include a security feature in which a Supplier enters its bid electronically by accessing the electronic PPD Auction site using a password that is unique to that Supplier. This feature prevents unauthorized use of the web-site and maintains the integrity of the Computerized Auction System, protecting the Suppliers, Purchasers and Funding Company.

Preferably, participating Suppliers are advised that Suppliers representing a dollar volume of Accounts Payable of a specified amount larger than the dollar volume of bids that will be accepted have been invited to bid and that there can be no guarantee that every bid that is submitted will be accepted. For example, but not by way of limitation, participating Suppliers are advised that Suppliers representing a dollar volume of Accounts Payable of a at least twice as large as the dollar volume of bids that will be accepted have been invited to bid. By conducting each PPD Auction in this manner, the largest possible discount from each Supplier may be obtained. Each Supplier will be bound to accept its Discounted Payment Amount for that PPD Auction as payment in full of Purchaser's obligation to Supplier for the Invoice included in that PPD Auction if the Supplier's bid is accepted.

A variety of means or methods can be used, both separately and in combination with one another, to process and pay Invoices at a discount under the AP System, including, but not limited to, payment by the Funding Company directly to each Supplier in a Supplier Pool by any means, such as cash, check, wire transfer, Automated Clearing House (“ACH”) payment, electronic funds transfer, or some other electronic transfer of funds; and a transfer of funds by the Funding Company to the Purchaser followed by payment from the Purchaser to each Supplier in a Supplier Pool.

The AP System may also include a mechanism by which the Purchaser initiates a wire transfer, an ACH Payment, or some other electronic transfer of funds to the Funding Company in an amount of up to the full face amount of the Invoices that were satisfied following a PPD Auction that will take place on a date that is an agreed upon number of days from the date on which the Funding Company made payment or began making payments to the Purchaser's Suppliers (a “Deferred Payment Authorization”). Thus, the AP System converts many Accounts Payable into one Deferred Payment Authorization that is a payment obligation of the Purchaser, preferably an absolute and unconditional obligation. Other payment methods may be used for the Purchaser to pay the Funding Company to satisfy the deferred obligation alone or in combination, including, but not limited to cash, check, or transfer of any other valuable asset held by the Purchaser, such as, but not limited to shares of stock.

A variety of means or methods can be used, both separately and in combination with one another, for a Purchaser to generate Deferred Payment Authorizations under the AP System, including, but not limited to, a wire transfer, ACH payment, or some other electronic transfer of funds that is authorized by the Purchaser and scheduled to occur at a specified date in the future; the issuance of a draft or some other form of confirmation that payment is due from the Purchaser to the Funding Company on a specified date; and the issuance of a promissory note from the Purchaser to the Funding Company which is due on a specified date in the future. In an embodiment of the invention, the Purchaser pays the payment obligation without deferring payment beyond the due date for payment under the Invoice that was processed through the AP System. In this way, the Purchaser takes advantage of the auction process to obtain the best possible prompt payment discount for the Invoice, without taking advantage of the deferred payment benefit. Typically, the Purchaser would pay the Funding Company an amount greater than the amount paid to the Suppliers, but at a later time, thereby deferring payment of the obligations represented by its Accounts Payable.

In certain embodiments of the invention, the Funding Company can create incentives for the Purchaser to make payment of the Deferred Payment Authorization. In one embodiment, the Funding Company may reduce the amount of payment due if the deferred payment is made on time. In another embodiment, the Funding Company may pay the Purchaser an amount of money (e.g., a percentage of the difference between the full face amount of the original obligation to the Supplier and the discounted amount paid to the Supplier) for timely paying the amount owed to the Funding Company. In this way, if the Purchaser fails to timely pay the obligation to the Funding Company, the additional monetary incentive is lost. This aspect of the invention benefits the Purchaser in that additional revenue may be generated from its Accounts Payable under the AP System over and above the benefit received from deferred payment, while providing the Funding Company with added assurances of timely payment of the Deferred Payment Authorization.

The deferred payment time is not particular limited, and will be agreed upon by the Purchaser and the Funding Company. Typically, deferred payments will be made within about 30, 60, 90, or 120 days, or in accordance with a payment schedule. Preferably, the deferred payment will be paid within about 30 to 90 days, ideally in about 60 to 90 days.

Financing a Deferred Payment Authorization has none of the risks associated with the financing of trade credit accounts as accounts receivable of Suppliers. Instead, a Deferred Payment Authorization is similar to commercial paper of a Purchaser with a strong credit rating with a maturity of from about 60 to 90 days. Given the quality of Deferred Payment Authorizations as a financial asset, the Funding Company can create a pool of Deferred Payment Authorizations from a number of Purchasers that will be similar to a diversified portfolio of short-term commercial paper from companies with excellent credit ratings and thereby command an extremely high credit rating. The high credit rating of this pool will enable the Funding Company to finance its portfolio of Deferred Payment Authorizations, and the AP System, at low interest rates through a variety of methods, including, but not limited to, the issuance of short-term commercial paper.

A variety of means or methods can be used, both separately and in combination with one another, by a Funding Company to fund the AP System by financing the Deferred Payment Authorizations that it receives from a Purchaser or from a number of Purchasers including, but not limited to, pooling Deferred Payment Authorizations from a number of Purchasers and then financing this diversified pool of short-term payment obligations through the issuance of short-term commercial paper; issuing short-term commercial paper that is secured or supported by Deferred Payment Authorizations that have been issued by one Purchaser; selling one or more Deferred Payment Authorizations at a discount: and obtaining advances under a revolving credit facility under which availability for funding is calculated based upon the value of the Deferred Payment Authorizations held by the Funding Company.

As will be apparent to those of ordinary skill in the art, from the descriptions set forth herein, the components or elements of the AP System can be structured or configured in many different ways to meet the needs and objectives of different Purchasers and Funding Companies without departing from the spirit and scope of the invention.

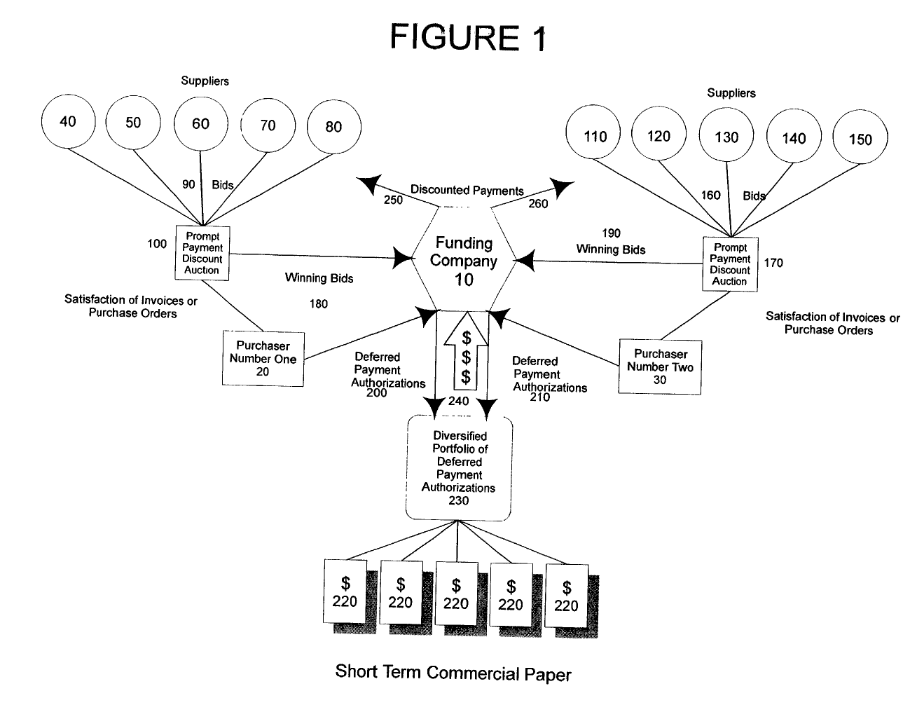

A preferred embodiment of the invention will now be described with reference to FIG. 1:

The AP System may be established with one or more Purchasers. Purchaser #1 20 with an excellent credit rating that purchases a large volume of goods and services on account through trade credit transactions enters into an AP System Contract with a Funding Company 10. Purchaser #2 30 also has an excellent credit rating and purchases a large volume of goods and services on account. Purchaser #2 30 also enters into an agreement with the Funding Company 10. The Funding Company 10 is a special purpose vehicle that has been formed by a large financial institution for the sole purpose of entering into AP System Contracts with Purchasers. The AP System Contracts between the Funding Company 10 and Purchaser #1 20 and Purchaser #2 30 are structured to meet the needs of Purchaser #1 20 and Purchaser #2 30.

In accordance with their respective AP System Contracts, Purchaser #1 20 and Purchaser #2 30 each select Suppliers that will be allowed to participate in a PPD Auction with respect to specific Invoices. A PPD Auction is held 100 in which each of the Suppliers 40, 50, 60, 70 and 80 of Purchaser #1 20 bids 90 a percentage discount from its Invoice to the Purchaser for prompt or accelerated payment of the amount of such Invoice less the prompt payment discount that has been bid. Separately, another PPD Auction 170 is held in which each of the Suppliers 110, 120, 130, 140, and 150 of Purchaser #2 30 bids 160 a percentage discount from its Invoice to the Purchaser for the prompt or accelerated payment of such Invoice less the prompt payment discount that it has bid. The winning, or accepted bids in the PPD Auctions 180, 190 are relayed to the Funding Company 10. The Funding Company 10 also receives a Deferred Payment Authorization 200 from Purchaser #1 20, and a Deferred Payment Authorization 210 from Purchaser #2. The Funding Company 10 issues short term commercial paper 220 that is backed or secured by its Deferred Payment Authorizations 230 from Purchaser #1 20 and Purchaser #2 30. Assuming all the Suppliers shown in FIG. 1 submit winning bids, the finds received 240 by the Funding Company 10 through its issuance of short term commercial paper are used to pay Purchaser #1's Suppliers 40, 50, 60, 70, 80 and Purchaser #2's Suppliers 110, 120, 130, 140, 150 the amount of their discounted Invoices 250, 260 in full satisfaction of the respective obligations of Purchaser #1 20 and Purchaser #2 30, to such Suppliers with respect to such Invoices. The Funding Company makes such payments to the Suppliers of Purchaser #1 20 and Purchaser #2 30 upon receiving confirmation from Purchaser #1 20 and Purchaser #2 30 that such Suppliers have performed in accordance with the terms of their Invoices.

In accordance with the Deferred Payment Authorization 200 that it delivered to the Funding Company 10 under its AP System Contract, Purchaser #1 20 pays the Funding Company 10 an amount greater than the discounted amount of the Invoices, up to the full amount of such Invoices, on a date certain. In accordance with the Deferred Payment Authorization 210 that it delivered to the Funding Company 10, Purchaser #2 30 pays the Funding Company 10 an amount greater than the discounted amount of the Invoices, up to the full amount of such Invoices, on a date certain. The Deferred Payment Authorizations are in the form of wire transfers that are scheduled to occur on a date that is an agreed upon number of days, which will be equal to the number of days in the extended payment terms that are to be provided to Purchaser #1 20 and Purchaser #2 30, from the date on which the Funding Company made payment or began making payments to Purchaser #1's Suppliers 40, 50, 60, 70, 80 and Purchaser #2's Suppliers 110, 120, 130, 140, 150, respectively.

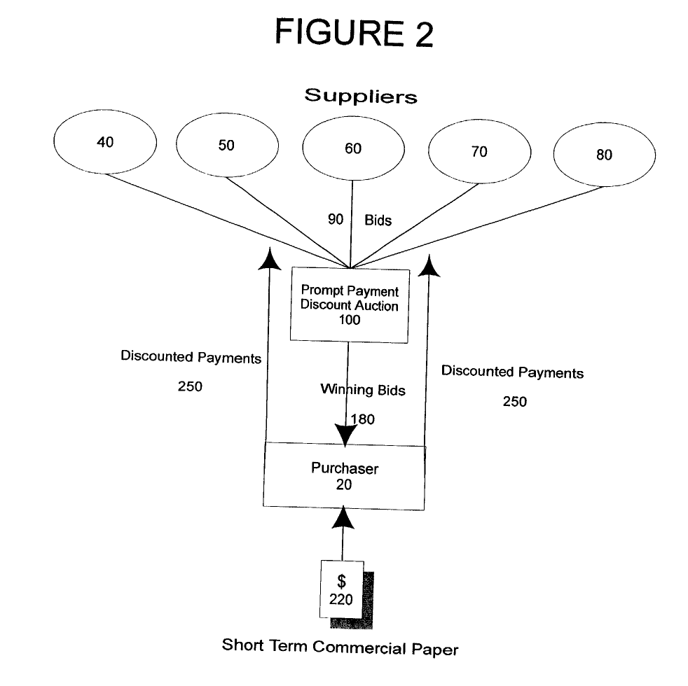

In another embodiment of the invention, shown schematically in FIG. 2, the Purchaser also serves as the Funding Company. This embodiment of the invention may be attractive to large companies having many Suppliers, and having the resources to implement the system without the involvement of a separate Funding Company. In this embodiment a Purchaser 20, with an excellent credit rating that purchases a large volume of goods and services on account through trade credit transactions enters into an agreement with select Suppliers 40, 50, 60, 70, 80, that will be allowed to participate in a PPD Auction with respect to specific Invoices. A PPD Auction is held 100 in which each of the Suppliers 40, 50, 60, 70 and 80 of the Purchaser 20 bids 90 a percentage discount from its Invoice to the Purchaser 20 for prompt or accelerated payment of the amount of such Invoice less the prompt payment discount that has been bid. Bids are accepted based on the requirements and specifications of the auction. Winning bids are transmitted to the Purchaser 20. The Purchaser 20 issues short term commercial paper 220 to finance discounted payment 250 to the Suppliers that have made winning bids 180 in the PPD Auction 100. The Purchaser makes the discounted payments to the Suppliers when Suppliers have performed in accordance with the terms of their Invoices. In this embodiment, Deferred Payment Authorizations are not involved as in the case with a separate Funding Company.

Preferred embodiments of the invention use a Computerized Auction System that can be accessed electronically through an Internet connection by the Purchaser, its Suppliers, and the Funding Company.

The computerized auction, as established with a computerized network is composed of components to implement a web-based auction. Such computerized web-based systems are well known in the art and descriptions of which can be found, for example, in U.S. Pat. No. 5,794,207, which is incorporated herein by reference in its entirety. Briefly, Supplier nodes are operably connected via a computer based network, such as an intranet or Internet connection to a server. Purchaser nodes are likewise connected to a server. In preferred embodiments, a Funding Company node is connected to the server as well. The connections are generally through a public switched phone network or through dedicated data lines, or through cellular, Personal Communication Systems, microwave or satellite networks. The server is equipped to process data input from the nodes using standard computer hardware and software having sufficient central processor (CPU) features, cryptographic processing features, random access memory, read only memory, data storage and all other necessary components that are well known in the art. The server may be programmed with the requirements and specifications of particular auctions. The server receives a schedule of Suppliers and accounts payable that are to be included in the auction from the Purchaser node and receives bids from the Supplier node. The server is programmed to compare the bids to the requirements and specifications of the particular auction and determines which bids are successful or acceptable. The server may transmit acceptance or rejection of a bid to the Supplier node, a Purchaser node and, in embodiments that include a Funding Company, to the Funding Company node.

In a preferred embodiment of the invention, upon accessing the Computerized Auction System through the Internet, each of these parties is presented with a different interface that allows it to view and obtain different information regarding a PPD Auction. The PPD Auction process provides an efficient and effective means of obtaining the largest possible prompt payment discounts from a Purchaser's Suppliers.

A description of a preferred embodiment using a Computerized Auction System is set forth below.

Upon the execution of an AP System Contract, the Funding Company may establish a Computerized Auction System for the Purchaser. It may be accessible through the Internet and interface with the Purchaser's accounting and other relevant information technology systems. The name, address, contact information, and preferred method of payment, for example, of each of the Purchaser's Suppliers are included in a database that is maintained as part of the Computerized Auction System. In addition, the Purchaser and each of its Suppliers are provided with their own user identification numbers and passwords for accessing the system.

During the set-up phase of a specific PPD Auction, the Purchaser provides a list of Suppliers that the Purchaser wishes to allow to participate in that auction to the Computerized Auction System. The names of the Suppliers on this list are cross-referenced to the specific Invoices of the Suppliers that are to be included in the PPD Auction. The Purchaser provides this list to the Computerized Auction System through an electronic file transfer or by other means. Using the information in its database regarding the Purchaser's Suppliers, the Computerized Auction System then invites such Suppliers to participate in the PPD Auction with respect to specific Invoices through e-mail, facsimile transmission, and other methods.

Upon being invited to participate in a PPD Auction, Suppliers may access the Computerized Auction System by visiting the web-site that has been established for that Purchaser under the AP System and entering a user identification number and password into a secure web-site interface. The interface for the Supplier may also include, for example, the ability for a Supplier to make administrative changes and corrections to the information provided by the Purchaser, if necessary.

Upon gaining access to the Computerized Auction System through this web site interface, Suppliers will enter confirmation that by participating in the PPD Auction and upon acceptance of the Supplier's bid, the Supplier will be bound to accept a prompt or accelerated payment (either immediately, or at a specified time) in an amount equal to the face amount of the Invoice minus the prompt payment discount that the Supplier bids, and that the prompt or accelerated payment will be in full satisfaction of the original obligation for the goods or services rendered to the Purchaser under such Invoice. The Supplier uses the computer terminal to input bids for prompt payment discounts for the accelerated payment of its Invoices in that PPD Auction. Based on its AP System Contract with the Purchaser, the Funding Company programs the Computerized Auction System to accept bids regarding a certain dollar volume of Invoices from the Purchaser's Suppliers that meet or exceed an agreed upon minimum discount. The computer program can compare the bid information that was entered by a Supplier to the predetermined minimum discount and automatically accept or reject bids based on the requirement and specifications of the particular PPD Auction. Upon the close of a PPD Auction, the Computerized Auction System (i) notifies each Supplier that bid whether its bid was accepted or rejected, and (ii) provides a summary report of the results of the PPD Auction to both the Purchaser and the Funding Company.

Following (i) the close of a PPD Auction, and (ii) confirmation from the Purchaser to the Funding Company through the Computerized Auction System that a Supplier has performed or delivered in accordance with its obligations to the Purchaser, the Funding Company makes an immediate payment by check, wire transfer, electronic transfer of funds, or other means on the Purchaser's behalf directly to each of the winning bidders in an amount equal to such bidder's Discounted Payment Amount as payment in full of the Invoice of such Supplier that was included in the PPD Auction. The Computerized Auction System generates all of the required payments for the Funding Company, and may maintain all records. Further the computer program may allow the Funding Company to generate reports of various types such as, but not limited to status of the PPD Auctions, payment history to given Suppliers, payment history for deferred payments of given Purchasers, history and profiles of Supplier's bids in current and previous auctions, analysis of dollar volumes processed in a Purchaser's PPD Auctions, revenue generated by the AP System for a given auction or Purchaser, revenue generated by the Funding Company for a given PPD Auction, analysis of a year's PPD Auctions, and the like.

The Purchaser issues an unconditional payment obligation to the Funding Company in an amount equal to the full face amount of the Invoices that were satisfied by the Funding Company through payments to the winning bidders under the computerized PPD Auction. This unconditional payment obligation is effected through a wire transfer that will be scheduled to be paid on a date that is an agreed upon number of days, which is equal to the number of days in the extended payment terms that are provided to the Purchaser with respect to the Invoices of the winning bidders in a PPD Auction, from the date on which the Funding Company made payment or began making payments to the Purchaser's Suppliers. Thus, the AP System converts many Accounts Payable into one Deferred Payment Authorization, preferably an absolute and unconditional payment obligation of the Purchaser.

A Purchaser is generally required to provide a Deferred Payment Authorization to the Funding Company upon or shortly after the close of each PPD Auction. Each Deferred Payment Authorization is a pre-authorized electronic transfer of funds from a Purchaser to the Funding Company that is (i) in an amount up to the full face amount of the Invoices that were paid on the Purchaser's behalf by the Funding Company through prompt or accelerated, discounted payments to the Suppliers that were the winning bidders in a PPD Auction, and (ii) scheduled to occur on a date that is after the PPD Auction (typically 60-90 days after the date on which the Funding Company made payment or began making payments to the Purchaser's Suppliers following the PPD Auction) depending on the extended payment terms that are provided to the Purchaser under its AP System Contract.

Once the Purchaser generates a Deferred Payment Authorization, the Funding Company accepts this financial obligation as payment in full for the Funding Company's satisfaction of a portion of the Purchaser's Accounts Payable at a discount through the PPD Auction and thus acquires a financial asset that is an absolute and unconditional obligation of the Purchaser to pay the Funding Company a specified amount on a future date.

A Deferred Payment Authorization has none of the ownership, fraud, or product or service performance risks associated with the financing of trade credit accounts as accounts receivable of Suppliers. Instead, a Deferred Payment Authorization is the equivalent of commercial paper of a Purchaser with a strong credit rating with a short-term maturity. Given the quality of a Deferred Payment Authorization as a financial asset, the Funding Company will be able to finance the AP System at very competitive interest rates, as shown in FIG. 1 by pooling Deferred Payment Authorizations 200, 210 from a number of Purchasers and then financing a diversified portfolio of Deferred Payment Authorizations 230 through the issuance of short-term commercial paper 220.

Various aspects of the invention are described in the Examples below. The Examples are merely illustrative of the invention and are not to be construed as limiting in any way.

### EXAMPLES

### Example 1

### The AP System

The Funding Company enters into an AP System Contract with Company A on Mar. 1, 2001. The AP System Contract provides, among other things, that Company A will receive (i) an additional 30 days beyond terms to pay its Accounts Payable, and (ii) a percentage of each prompt payment discount bid through a PPD Auction calculated as 20% of the first 2% of each prompt payment discount and 50% of any prompt payment discount greater than 2%.

On Mar. 15, 2001, Company A notifies Suppliers that will represent $2 billion of Accounts Payable upon the delivery of goods to or the performance of services for Company A on or about Mar. 31, 2001 that they will have the opportunity to participate in a PPD Auction that will enable them to bid prompt payment discounts for the immediate payment of the balance of their Invoices to Company A. Such Suppliers are further advised that this offer is being made to Suppliers representing $2 billion of Accounts Payable and that bids from Suppliers representing $1 billion of Accounts Payable will be accepted.

The first Company A PPD Auction closes on Mar. 25, 2001. Bids for a face amount of $1 billion of Accounts Payable are accepted for a cumulative discount of $35 million or 3.5% of the face amount of such Accounts Payable. Upon receiving confirmation from Company A that goods have been delivered and that services have been performed, the Funding Company pays $965 million to the Suppliers that submitted the winning bids. One billion dollars of Accounts Payable of Company A are eliminated. Company A initiates a $1 billion electronic transfer of finds to the Funding Company that will be made on May 30, 2001, the date that is 60 days from the date on which the Funding Company made payment to Company A's Suppliers. Company A receives 30 extra days to pay what would have been $1 billion of Accounts Payable with 30 day terms. Assuming that Company A is able to borrow on a short-term basis at an interest rate of 7% per annum, this 30 days of interest free float on $1 billion saves Company A approximately $5.7 million of interest expense. In addition to this savings, Company A also would accrue an $11.5 million payment as its share of the prompt payment discounts bid at the PPD Auction. Thus, Company A would add approximately $17.2 million to its bottom line by processing $1 billion of its Accounts Payable through the AP System. This benefit will increase in direct relation to the dollar volume of Accounts Payable that Company A chooses to process through the AP System. Accordingly, under the assumptions of this example, Company A will be able to add $100 million to its bottom line if it chooses to process $6 billion through the AP System over the course of a year through six PPD Auctions.

Under the assumptions of this hypothetical example, the Funding Company will realize gross revenue of $210 million by processing $6 billion of Company A's trade payables through the AP System. The Funding Company will achieve this revenue figure by conducting six PPD Auctions that will each result in a cumulative prompt payment discount of $35 million. From this $210 million in gross revenues, the Funding Company will make $69 million in revenue sharing payments to Company A.

As an example of how a Purchaser may receive a financial benefit from the AP System, under different assumptions, a Purchaser that receives an additional 60 days beyond terms under its AP System Contract and processes $4 billion of its Accounts Payable through the AP System during the course of the year in four separate PPD Auctions in which bids with respect to $1 billion of accounts payable are accepted receives an additional 240 days of interest free float on $1 billion without stretching its Accounts Payable. Assuming an interest rate of 7% per annum for this credit worthy Purchaser, this additional float will save the Purchaser approximately $46 million in interest expense. Each Purchaser that utilizes the AP System also may benefit financially by receiving a percentage of the prompt payment discounts that its Suppliers provide to the Funding Company under a PPD Auction to obtain the prompt or accelerated payment of their Invoices. These percentage payments can be significant. Assuming that the Purchaser in this example receives 20% of the first 2% of prompt payment discount and 50% of any prompt payment discount greater than 2% under its AP System Contract, a Purchaser should net an additional $36 million per year as its share of the prompt payment discounts generated through PPD Auctions for $4 billion of payables if the average prompt payment discount bid by the winning Suppliers in each of four PPD Auctions is 3%.

A Purchaser receives many significant benefits from the AP System without any cost or expense and without the Purchaser incurring any additional debt. Each Purchaser that utilizes the AP System thus benefits financially. For example, under the AP System, each Purchaser may receive an additional amount of time to pay its Accounts Payable at no charge. These extended payment terms enable such Purchasers to improve their cash flow and reduce their interest expense.

The AP System also provides Purchasers with administrative cost savings. The AP System converts the tracking and payment of many Accounts Payable into an obligation to make one large payment on a specific date. Thus, the AP System reduces the work that must be done by the Purchaser's accounts payable department.

The AP System should also enable Purchasers to improve their relationships with their Suppliers through prompt payment. The AP System allows Purchasers to improve their cash flow by taking longer to pay their trade credit obligations without stretching their Accounts Payable at the expense of their Suppliers.

Suppliers that participate in the AP System also will benefit. The AP System provides Suppliers with a means to accelerate their cash flow without the need to enter into expensive, restrictive, long-term contracts or commitments with Commercial Finance Companies. To begin with, the AP System will provide each Supplier with a much larger payment with respect to an Invoice than it would receive through an advance under a factoring or accounts receivable based financing program. The AP System will provide Suppliers with prompt or accelerated payments for their Invoices in amounts that will, in most cases, exceed 95% of the face amount of those Invoices. Commercial Finance Companies typically will not provide a Supplier with an advance rate of 95% of its qualified accounts receivable. In fact, the upper advance rate limit for most Commercial Finance Companies is 80% of qualified accounts receivable. The AP System is also more flexible than factoring or accounts receivable based financing. Generally, Commercial Finance Companies will require a Supplier to pledge and/or finance all of its receivables, even if the Supplier only has a seasonal or occasional need for finding. Under the AP System, the Supplier benefits on a transaction-by-transaction basis and without any long-term contracts or commitments.

In addition, the Supplier's cost of funds under the AP System should be much lower than under accounts receivable financing programs in most cases. The cost of finds from a Commercial Finance Company, once all service fees, discount fees, and interest charges are totaled, will range from 18% per annum for the best customers to nearly 50% per annum for the riskiest customers.

### Example 2

### The Computerized Auction System

In a web-based computerized auction system, a Supplier will login to the PPD Auction System by entering its name, identification number and password on the main menu of the website in order to gain access to subsequent menus. The PPD Auction System may have additional security systems and measures for its Supplier Login module.

Once the Supplier has gained access to the PPD Auction System, the Supplier will be presented with a Main Menu screen. The Supplier Main Menu Screen provides the Supplier with six options: (1) PPD Auction bidding, (2) an explanation of the PPD Auction Process and Procedures, (3) PPD Auction History and Status, (4) AP System Benefits, (5) Administrative Changes, and (6) Logout.

The PPD Auction Bidding selection allows the Supplier to access the menu for inputting bids for prompt payment discounts for one or more specific Invoices of a Purchaser that the Purchaser has elected to include in the PPD Auction. The Supplier will not be able to bid prompt payment discounts with respect to an Invoice that the Purchaser has not elected to include in the PPD Auction. Upon submission of a bid, the Supplier will again confirm that the Supplier agrees to accept prompt payment of an amount equal to the face amount of the Invoice minus the discount bid for any accepted bid in full satisfaction of the original obligation for the goods and services provided under that Invoice.

The Explanation of the PPD Auction Process and Procedures option will take the Supplier to a page that describes the PPD Auction process in detail, including all the requirements and procedures.

The PPD Auction History and Status option will take the Supplier to a page wherein the Supplier can review a summary of the prompt payment discount bids that it has made in the past and the results of those bids. This may aid a Supplier in determining an appropriate bid. In addition, a Supplier will be able to obtain the status of any pending PPD Auctions in which it has participated.

The AP System Benefits option will take the Supplier to a page wherein the Supplier can learn of the many benefits that the AP System provides, including, but not limited to, higher advance rates, lower costs to the Supplier, absence of long-term commitments or contracts, and the like. Furthermore, the Supplier may also use a calculator that compares the AP System to factoring and other accounts receivable based financing programs.

The Administrative Changes option will take the Supplier to a page in which the Supplier can make changes to its set-up and registration information under the PPD Auction System, and make any corrections to the information about the Supplier that has been entered by the Purchaser.

The Logout option enables the Supplier to exit the PPD Auction System from the Supplier Main Menu.

The Purchaser accesses the main page of the website and accesses the PPD Auction System by entering its name, identification number, and its PPD Auction System password. The PPD Auction System may have additional security systems and measures for its Purchaser Login module.

Once the Purchaser has accessed the PPD Auction System by logging in, the Purchaser will be presented with a Purchaser Main Menu Screen that provides seven options: (1) Create a Schedule of Suppliers and Invoices for a PPD Auction, (2) Review Status of Pending PPD Auctions, (3) Summary of PPD Auction Results to Date (4) Confirmation of Supplier Delivery or Performance, (5) Generation of a Deferred Payment Authorization, (6) Administrative Changes, and (7) Logout.

The Create a Supplier Schedule option allows the Purchaser to input information to control whether a Supplier can participate in a PPD Auction and which Invoices are eligible to participate in a particular PPD Auction. The PPD Auction System will interface with the Purchaser's accounting systems and enables the Purchaser to easily schedule (a) the Suppliers, and (b) the Invoices of those Suppliers that are eligible to participate in the particular PPD Auction.

The Review of Status of Pending PPD Auctions option brings the Purchaser to a page that allows the Purchaser to get a status report with respect to a pending PPD Auction to determine the number of Suppliers participating in the PPD Auction, the dollar volume of the Invoices represented by bids that have been made, and the average of the prompt payment discounts bid by the participating Suppliers to date.

The Summary of the PPD Auction results to Date brings the Purchaser to a page wherein the Purchaser can review the statistics of each PPD Auction that has taken place for its Suppliers current through the date of the Purchaser's login.

The Confirmation of Supplier Delivery or Performance option brings the Purchaser to a page that interfaces with the Purchaser's accounting system and enables the Purchaser to advise the PPD Auction System when a Supplier that has submitted a winning bid in a PPD Auction has performed with respect to the Invoice covered by that Supplier's winning bid.

The Administrative Changes option brings the Purchaser to a page that enables the Purchaser to make any necessary changes to its set-up or registration information under the PPD Auction System.

The Logout option simply allows the Purchaser to exit the PPD Auction System from the Purchaser Main Menu.

The Funding Company may login to the PPD Auction website by entering its name, identification number, and PPD Auction System password. The PPD Auction System may have additional security systems and measures for its Funding Company Login module.

Upon successfully logging into the PPD Auction System website, the Funding Company is taken to a Funding Company Main Menu Screen. The Funding Company Main Menu Screen provides the Funding Company with eight options: (1) Program PPD Auction System to conduct a Specific PPD Auction, (2) Review Status of Purchaser's Deferred Payment Authorizations to Date, (3) Review Status of Pending PPD Auctions, (4) Summary of PPD Auction Results to Date, (5) Schedule Payments to Successful Bidders, (6) Summary of Payments Made Upon Confirmation of Supplier Delivery or Performance, (7) Administrative Changes, and (8) Logout.

The Program PPD Auction System option takes the Funding Company to a page that enables the Funding Company to input information into the system to set up a particular auction based on its AP System Contract with the Purchaser. The Funding Company inputs information regarding, among other things, the minimum prompt payment discount threshold that bids must meet or exceed in order to be accepted, and the dollar volume of bids that will be accepted.

The Review Status of Purchaser's Deferred Payment Authorizations option takes the Funding Company to a page that enables the Funding Company to utilize the PPD Auction System to review the status of the Deferred Payment Authorizations that the Purchaser has generated under the AP System to date.

The Review Status of Pending PPD Auctions takes the Funding Company to a page that enables the Funding Company to examine the status of pending PPD Auctions and determine the number of Suppliers that have submitted bids, the dollar volume of Invoices that are represented by the submitted bids, the prompt payment discount or discounts that have been bid by each Supplier, and the average of the prompt payment discounts that have been bid by the Suppliers to date.

The Summary of the PPD Auction Results to Date option takes the Funding Company to a page wherein the Funding Company will be able to receive the statistics of each of the PPD Auctions that have taken place for the Purchaser to date.

The Schedule Payments to Successful Bidders option takes the Funding Company to a page wherein the Funding Company will be able to schedule payments to the Suppliers that have submitted winning bids in the particular auction. Payments may be scheduled to take place upon confirmation from the Purchaser that the winning bidders (Suppliers) have performed.

The Summary of Payments Made option brings the Funding Company to a page that enables the Funding Company to review a summary of all of the payments made to the Purchaser's Suppliers under the AP System.

The Administrative Changes option brings the Funding Company to a page that enables the Funding Company to change its set-up or registration information under the PPD Auction System.

The logout option allows the Funding Company to exit the PPD Auction System from the Funding Company Main Menu.

The Program in the PPD Auction System site performs five primary functions: (1) it provides a means of transferring and sharing information between and among a Purchaser, its Suppliers, and the Funding Company in a secure environment, (2) it processes bids submitted in the auction, (3) it generates instructions for payments that need to be made under the AP System, (4) it compiles statistics on the PPD Auctions, and (5) it generates reports for the parties.

The transferring of information function permits sharing of information between and among the Funding Company, Purchaser, and Purchaser's Supplier(s). This function interfaces directly with the Purchaser's accounting system and allows the Purchaser to transfer a list of eligible Suppliers and of eligible Invoices directly from its accounting system, and to import a list of winning bidders and the Invoices that are covered by their winning bids directly into its accounting system. The PPD Auction System also serves notice functions: Suppliers are notified of their selection and of the eligible Invoices for a particular PPD Auction, Suppliers are notified whether their bids were successful, and the Funding Company and Purchaser are notified as to the identity of the winning bidders and their bids. The Funding Company and the Purchaser may additionally determine the status of the bidding of a particular auction by accessing the system. The PPD Auction System also allows a Purchaser to notify the Funding Company whether the winning bidder has performed.

The PPD Auction System program also automatically processes the bids submitted. The PPD Auction System may be programmed to conduct auctions of various types, depending on the needs of the Purchaser and/or its Suppliers. The PPD Auction System can be programmed to conduct a PPD Auction that accepts a certain dollar volume of bids that meet or exceed a certain minimum prompt payment discount threshold. The PPD Auction System will accept bids from eligible Suppliers regarding eligible Invoices, calculate whether such bids exceed the required minimum bid for that auction, and calculate which bids that exceed the required minimum bid for that auction are the highest bids that equal the dollar volume of Accounts Payable that are to be processed and converted into a Deferred Payment Authorization through that PPD Auction.

The Generation of Payments function of the program generates the payments that need to be made to the wining bidders in each PPD Auction. Such payments, however, will not be released without the approval of the Funding Company which approval only will come after the Funding Company receives notification from the Purchaser that the winning bidders have performed. The PPD Auction System also can generate the Deferred Payment Authorization that the Purchaser needs to deliver to the Funding Company in connection with the PPD Auction. Such Deferred Payment Authorization will not be released without the approval of the Purchaser.

The key to the AP System is that it eliminates the inequities and inefficiencies of the existing methods of financing trade credit accounts through a unique and proprietary financial engineering process that consolidates a Purchaser's Accounts Payable and then converts them into a new financial obligation that represents an absolute and unconditional obligation of the Purchaser to make a payment to the Funding Company on a specified date. Through this financial engineering, the Funding Company will transform a Purchaser's Accounts Payable into a new financial asset that is the equivalent of short-term commercial paper of the Purchaser with a maturity of from 60 to 90 days. This new financial asset will not have the ownership, fraud, credit, or product or service performance risks that are present in financing “accounts” as accounts receivable. Accordingly, the AP System will be much more efficient from an operational perspective because a Funding Company will not have to incur the time nor the transactional costs that are necessary to manage these risks under accounts receivable finance programs.

Similarly, the AP System will be far more efficient than existing methods of trade credit finance from a financing perspective. Under the AP System, the Funding Company will not be forced to manage or balance a portfolio of accounts receivable that it obtains from an accounts receivable financing client. Instead, the Funding Company will be able to easily and efficiently package the new financial assets that are created under the AP System from a variety of Purchasers to create a diversified portfolio of unconditional short-term payment obligations of companies with strong credit ratings. A Funding Company will then be able to access the institutional credit markets to finance or securitize this diversified portfolio of short-term payment obligations of credit-worthy companies at an extremely attractive interest rate. In sum, the AP System represents a more efficient and effective means of financing trade credit accounts at a lower interest rate.

I claim:

1. A method of processing and converting at least one account payable into a new obligation, comprising the steps of:
a Funding Company entering into an agreement with at least one Purchaser having an account payable owing or to become owing to at least one Supplier, said Purchaser agreement establishing the terms and conditions under which said account payable will be processed and satisfied at a discount on behalf of said Purchaser by said Funding Company;
obtaining the agreement of said Supplier to accept a discounted amount with respect to said account payable of said Purchaser in exchange for the accelerated payment of said discounted amount;
pursuant to said agreement, said Funding Company receiving an obligation of said Purchaser to pay an amount equal to or greater than said discounted amount paid to said Supplier, on a date after the date of payment to said Supplier by the Funding Company;
said Funding Company financing payment to said Supplier of said discounted amount;
pursuant to said Supplier agreement, said Funding Company transferring to said Supplier an amount to satisfy payment of said discounted amount; and
said Funding Company receiving payment from said Purchaser with respect to said obligation of said Purchaser of said amount equal to or greater than said discounted payment amount.

2. The method of claim 1, wherein the step of obtaining the agreement of said Supplier to accept said discounted amount includes the step of agreeing to conduct an auction wherein at least one of said Suppliers bids a percentage discount with respect to an account payable of said Purchaser owing or to become owing to said Supplier for the accelerated payment of said account payable, wherein a bid is accepted or rejected in accordance with requirements and specifications of the auction so as to determine said discounted amount for said account payable.

3. The method of claim 2, wherein said requirements and specifications of said auction comprise a threshold value of acceptable percentage discounts, wherein a successful bid equals at least said threshold value.

4. The method of claim 3, wherein said requirements and specifications of said auction comprise a dollar value limit to the amount of accounts payable to be accepted and paid by said Funding Company, wherein a successful bid offers the largest percentage discount or discounts and is made with respect to accounts payable that collectively equal a dollar value that meets said dollar value limit of said accounts payable to be accepted and paid by said Funding Company.

5. The method of claim 3, wherein said requirements and specifications of said auction comprise a dollar value limit to the discounted payments to be made with respect to successful bids, wherein a successful bid offers a largest percentage discount and results in a discounted payment that together with other successful bids meets said dollar value limit of discounted payments to be made.

6. The method of claim 2, wherein said auction is conducted in an electronic medium comprising the further step of at least one of said Suppliers communicating from a remote location a bid of a percentage discount with respect to an account payable of said Purchaser owing or to become owing to said Supplier for the accelerated payment of said account payable.

7. The method of claim 2, wherein said auction is conducted over a computerized network and said auction comprises the steps of: at least one Supplier inputting a bid, wherein said bid comprises a percentage discount with respect to an account payable of said Purchaser owing or to become owing to said Supplier for the accelerated payment of said account payable at a discount, posting said bid to a server, and one of said Purchaser and said Funding Company inputting an acceptance or rejection of said bid in accordance with the requirements and specifications of the auction.

8. The method of claim 7, wherein said posting step comprises the step of said Supplier inputting its name, an identification number, and a password to said server.

9. The method of claim 7, further comprising the step of said Funding Company receiving a notice from said Purchaser of an acceptable bid through said computerized network.

10. The method of claim 7, further comprising the step of said Funding Company notifying said Purchaser of an acceptable bid through said computerized network.

11. The method of claim 1, wherein the step of said Funding Company receiving an obligation of said Purchaser comprises the step of said Purchaser initiating at least one of a wire transfer, an automated clearing house payment, and an electronic transfer of funds to said Funding Company, in a specified amount, that is scheduled to transfer said amount equal to or greater than said discounted amount on a specified date in the future.

12. The method of claim 11, wherein the specified amount of said obligation of said Purchaser is equal to the amount of said account payable.

13. The method of claim 1, wherein the step of said Funding Company receiving an obligation of said Purchaser comprises the step of said Purchaser issuing at least one of a draft and a confirmation to the Funding Company that payment of a specified amount is due from the Purchaser to the Funding Company on a specified date in the future.

14. The method of claim 13, wherein the specified amount of said obligation of said Purchaser is equal to the amount of said account payable.

15. The method of claim 1 wherein the step of said Funding Company receiving an obligation of said Purchaser comprises the step of issuing a promissory note from the Purchaser to the Funding Company that is for a specified amount and due on a specified date in the future.

16. The method of claim 15, wherein the specified amount of said obligation of said Purchaser is equal to the amount of said account payable.

17. The method of claim 1, wherein the step of said Funding Company financing payment to said Supplier of said discounted amount comprises the step of said Funding Company using at least one of existing and self-generated funds.

18. The method of claim 1, wherein the step of said Funding Company financing payment to said Supplier of said discounted amount comprises the step of said Funding Company obtaining a loan that is based upon, backed, or secured by said payment obligation of said Purchaser.

19. The method of claim 1, wherein the step of said Funding Company financing payment to said Supplier of said discounted amount comprises the step of said Funding Company issuing commercial paper that is backed or secured by said payment obligation of said Purchaser.

20. The method of claim 1, wherein the step of said Funding Company financing payment to said Supplier of said discounted amount comprises the step of said Funding Company selling said obligation of said Purchaser at a discount.

21. The method of claim 1, wherein the step of transferring payment to said Supplier of said discounted amount comprises the step of said Funding Company transferring said payment to said Supplier through an electronic wire transfer.

22. The method of claim 1, wherein the step of transferring payment to said Supplier of said discounted amount comprises said Funding Company transferring said payment to said Supplier using at least one of the steps of passing the funds through an automated clearing house and electronically transferring funds.

23. The method of claim 1, wherein the step of transferring payment to said Supplier of said discounted amount comprises said Funding Company transferring said payment to said Supplier by delivering a check.

24. The method of claim 1, wherein the step of said Funding Company receiving payment from said Purchaser with respect to said obligation of said Purchaser comprises the step of said Purchaser transferring said payment to said Funding Company through an electronic wire transfer.

25. The method of claim 1, wherein the step of said Funding Company receiving payment from said Purchaser with respect to said obligation of said Purchaser comprises said Purchaser transferring said payment to said Funding Company through at least one of the steps of passing the funds through an automated clearing house and electronically transferring funds.

26. The method of claim 1, wherein the step of said Funding Company receiving payment from said Purchaser with respect to said obligation of said Purchaser comprises the step of said Purchaser transferring said Payment to said Funding Company by delivering a check.

27. The method of claim 1, wherein the step of said Funding Company entering into an agreement with at least one Purchaser comprises the step of said Funding Company entering into a plurality of agreements with a plurality of Purchasers.

28. The method of claim 1, wherein the step of obtaining the agreement of said Supplier to accept a discounted amount comprises the step of entering into a plurality of agreements with a plurality of Purchasers, said agreements setting forth procedures for obtaining the agreement of a plurality of Suppliers to accept discounted amounts with respect to a plurality of accounts payable of said plurality of Purchasers in exchange for the accelerated payment of said discounted amounts.

29. The method of claim 28, wherein the step of obtaining the agreement of a plurality of Suppliers to accept discounted amounts with respect to a plurality of accounts payable of said plurality of Purchasers includes the step of agreeing to conduct a plurality of auctions for the Suppliers of a plurality of Purchasers wherein in each auction at least one of said Suppliers bids a percentage discount with respect to an account payable of a Purchaser owing or to become owing to said at least one Supplier for the accelerated payment of said account payable, wherein a bid is accepted or rejected in accordance with requirements and specifications of the auction so as to determine said discounted amount for said account payable.

30. The method of claim 29, wherein said requirements and specifications of at least one of said plurality of auctions comprise a threshold value of acceptable percentage discounts, wherein a successful bid equals at least said threshold value.

31. The method of claim 30, wherein said requirements and specifications of at least one of said plurality of auctions comprise a dollar value limit to the amount of accounts payable to be accepted and paid by said Funding Company, wherein a successful bid offers the largest percentage discount or discounts and is made with respect to accounts payable that collectively equal a dollar value that meets said dollar value limit of said accounts payable to be accepted and paid by said Funding Company.

32. The method of claim 30, wherein said requirements and specifications of one or more of said plurality of auctions further comprise a dollar value limit to the discounted payments to be made with respect to successful bids, wherein a successful bid offers the largest percentage discount or discounts and which will result in discounted payments that meet said limit of discounted payments to be made.

33. The method of claim 29, wherein at least one of said plurality of auctions is conducted in an electronic medium comprising the further step of at least one of said Suppliers communicating a bid of a percentage discount with respect to an account payable of said Purchaser owing or to become owing to said Supplier for the accelerated payment of said account payable.

34. The method of claim 29, wherein at least one of said plurality of auctions is conducted over a computerized network, said at least one auction comprising the steps of: at least one Supplier inputting a bid, wherein said bid comprises a percentage discount with respect to an account payable of a Purchaser owing or to become owing to said Supplier for the accelerated payment of said account payable at a discount, posting said bid to a server, and one of said Purchaser and said Funding Company inputting an acceptance or rejection of said bid in accordance with the requirements and specifications of said at least one auction.

35. The method of claim 1, wherein the step of said Funding Company receiving an obligation of said Purchaser comprises said Funding Company receiving a plurality of obligations from a plurality of Purchasers under a plurality of agreements.

36. The method of claim 35, wherein the step of said Funding Company receiving a plurality of obligations from a plurality of Purchasers comprises the step of at least one of said Purchasers initiating at least one of a wire transfer, an automated clearing house payment, and an electronic transfer of funds to said Funding Company, in a specified amount, that is scheduled to occur on a specified date in the future.

37. The method of claim 36, wherein the specified amount of at least one of said obligations of said plurality of Purchasers is equal to the amount of said account payable.

38. The method of claim 35, wherein the step of said Funding Company receiving a plurality of obligations from a plurality of Purchasers comprises the step of at least one of said plurality of Purchasers issuing one of a draft and a confirmation to the Funding Company that payment of a specified amount is due from a Purchaser to the Funding Company on a specified date in the future.

39. The method of claim 38, wherein the specified amount of at least one of said obligations of said plurality of Purchasers is equal to the amount of said account payable.

40. The method of claim 35, wherein the step of said Funding Company receiving a plurality of obligations from a plurality of Purchasers comprises the step of at least one of said plurality of Purchasers issuing a promissory note to the Funding Company that is in a specified amount and due on a specified date in the future.

41. The method of claim 40, wherein the specified amount of at least one of said obligations of said plurality of Purchasers is equal to the amount of said account payable.

42. The method of claim 1, wherein the step of said Funding Company financing payment to said Supplier comprises said Funding Company financing payments to a plurality of Suppliers of a plurality of discounted payments.

43. The method of claim 42, wherein the step of said Funding Company financing payment to a plurality of Suppliers of a plurality of discounted amounts comprises the step of said Funding Company using at least one of existing and self-generated funds.

44. The method of claim 42, wherein the step of said Funding Company financing payment to a plurality of Suppliers of a plurality of discounted amounts comprises the step of said Funding Company obtaining a loan that is based upon, backed, or secured by a plurality of payment obligations of a plurality of Purchasers.

45. The method of claim 42, wherein the step of said Funding Company financing payment to a plurality of Suppliers of a plurality of discounted amounts comprises the step of said Funding Company issuing commercial paper that is backed or secured by a plurality of payment obligations of a plurality of Purchasers.

46. The method of claim 42, wherein the step of said Funding Company financing payment to a plurality of Suppliers of a plurality of discounted amounts comprises the step of said Funding Company selling a plurality of obligations of a plurality of Purchasers at a discount.

47. The method of claim 1, wherein said step of said Funding Company transferring to said Supplier an amount to satisfy payment of said discounted amount comprises the step of said Funding Company transferring to a plurality of Suppliers a plurality of amounts to satisfy payment of a plurality of discounted amounts.

48. The method of claim 47, wherein the step of said Funding Company transferring to a plurality of Suppliers a plurality of amounts to satisfy a plurality of discounted amounts comprises the step of said Funding Company transferring said payment to at least one of said plurality of Suppliers through an electronic wire transfer.

49. The method of claim 47, wherein said step of said Funding Company transferring to a plurality of Suppliers a plurality of amounts to satisfy a plurality of discounted amounts comprises the step of said Funding Company transferring said payment to at least one of said plurality of Suppliers using at least one of the steps of passing the funds through one of an automated clearing house and electronically transferring funds.

50. The method of claim 47, wherein said step of said Funding Company transferring to a plurality of Suppliers a plurality of amounts to satisfy a plurality of discounted amounts comprises the step of said Funding Company transferring said payment to at least one of said plurality of Suppliers by delivering a check.

51. The method of claim 1, wherein said step of said Funding Company receiving payment from said Purchaser with respect to said obligation of said Purchaser comprises the step of said Funding Company receiving payment from a plurality of Purchasers with respect to a plurality of obligations of a plurality of Purchasers.

52. The method of claim 51, wherein said step of said Funding Company receiving payment from a plurality of Purchasers with respect to a plurality of obligations of a plurality of Purchasers comprises the step of at least one of said plurality of Purchasers transferring payment to said Funding Company through an electronic wire transfer.

53. The method of claim 51, wherein said step of said Funding Company receiving payment from a plurality of Purchasers with respect to a plurality of obligations of a plurality of Purchasers comprises the step of at least one of said plurality of Purchasers transferring payment to said Funding Company through at least one of the steps of passing the funds through an automated clearing house and electronically transferring funds.

54. The method of claim 51, wherein said step of said Funding Company receiving payment from a plurality of Purchasers with respect to a plurality of obligations of a plurality of Purchasers comprises the step of at least one of said plurality of Purchasers transferring payment to said Funding Company through the delivery of a check.

55. A computerized auction system for processing and converting at least one account payable into a new obligation over a computerized network, comprising:
a Supplier node used by a Supplier to input bids of percentage discounts with respect to an account payable of a Purchaser owing or to become owing to said Supplier for the accelerated payment of said account payable;
a Purchaser node used by said Purchaser to schedule the Suppliers and the accounts payable that are to be included in an auction, to advise a Funding Company when a Supplier has performed in connection with an account payable, and to authorize the delivery of a payment obligation to a Funding Company;
a Funding Company node used by a Funding Company to program the requirements and specifications of a particular auction and to authorize the making of discounted payments to Suppliers; and
a server programmed with the requirements and specifications of a particular auction from said Funding Company node, said server receiving a schedule of Suppliers and accounts payable that are to be included in an auction from said Purchaser node, receiving bids from said Supplier node, comparing said bids to the requirements and specifications of the auction to determine successful or acceptable bids, and transmitting notification of acceptance or rejection of a bid to said Supplier node, Purchaser node, and Funding Company node.

56. An auction system as in claim 55, wherein said Supplier node, Purchaser node and Funding Company node communicate with each other to provide information regarding an auction.

57. An auction system as in claim 55, wherein said server maintains a database of information regarding a Purchaser's Suppliers.

58. An auction system as in claim 55, wherein said server generates reports regarding the results of an auction and transmits said reports to said Purchaser node and said Funding Company node.

59. An auction system as in claim 55, wherein said server schedules the discounted payments to be made to said Suppliers that submitted winning bids.

60. An auction system as in claim 55, wherein said server schedules a payment obligation to be delivered from a Purchaser to a Funding Company.

61. A method of converting at least one account payable into a new obligation using a computerized auction system, comprising the steps of:
a Funding Company entering into at least one agreement with at least one Purchaser having an account payable owing or to become owing from at least one Supplier that defines the terms and conditions under which said account payable will be processed and satisfied at a discount on behalf of said Purchaser by said Funding Company;
said Funding Company establishing a computerized auction system over a computerized network in accordance with said agreement that includes a database of information regarding said Purchaser's Suppliers;
programming a server of said computerized auction system with the requirements and specifications for the auction;
receiving from said Purchaser a list of Suppliers and accounts payable of said Purchaser that said Purchaser wishes to be included in an auction and providing said list to the server;
the server notifying the Suppliers on the list generated by the Purchaser of the auction and of the accounts payable for which the Supplier may enter bids in the auction;
receiving from each Supplier that chooses to participate in said auction a bid, wherein each such bid comprises a percentage discount with respect to an account payable of said Purchaser owing or to become owing to each said Supplier for the accelerated payment of said account payable, each bid being posted to said server;
the server processing the bids entered by Suppliers in accordance with the requirements and specifications of the auction and determining the winning or successful bids under said auction, and advising each Supplier that bid whether its bid was accepted or rejected.

62. The method of claim 61, comprising the further steps of said server preparing a report regarding said auction results and transmitting said report to the Purchaser and the Funding Company.

63. The method of claim 61, comprising the further steps of said server scheduling the payments to be made to the Suppliers that submitted the winning bids using payment specifications from a database of information regarding a Purchaser's Suppliers and generating a payment obligation from the Purchaser to the Funding Company.

64. The method of claim 63, comprising the further step of receiving from the Purchaser confirmation of the payment obligation from said Purchaser to said Funding Company.

65. The method of claim 64, comprising the further step of the Funding Company issuing commercial paper that is backed or secured by said payment obligation of said Purchaser.

66. The method of claim 64, comprising the further steps of receiving from the Purchaser confirmation that each Supplier that submitted a winning bid has performed, the Funding Company initiating or releasing payment to each Supplier that has performed upon receiving confirmation of such performance from said Purchaser, and the Funding Company receiving a wire transfer from said Purchaser to satisfy said obligation of said Purchaser to said Funding Company.

67. A method of processing and converting at least one account payable into a new obligation, comprising the steps of:
a Purchaser having an account payable owing or to become owing from at least one Supplier entering into an agreement with said at least one Supplier to accept a discounted amount with respect to said account payable of said Purchaser in exchange for the accelerated payment of said discounted amount, said discounted amount being determined by an auction wherein at least one of said Suppliers bids a percentage discount with respect to an account payable of said Purchaser owing or to become owing to said Supplier for the accelerated payment of said account payable, and said bid is accepted or rejected in accordance with requirements and specifications of the auction, accepted bids determining said discounted amount for said account payable;
said Purchaser transferring to said Supplier an amount to satisfy payment of said discounted amount; and
said Purchaser financing payment to said Supplier of said discounted amount.

68. The method of claim 67, wherein said requirements and specifications of said auction comprise a threshold value of acceptable percentage discounts, wherein a successful bid equals at least said threshold value.

69. The method of claim 68, wherein said requirements and specifications of the auction comprise a dollar value limit to the amount of accounts payable to be accepted and paid, wherein a successful bid offers the largest percentage discount or discounts and which is made with respect to accounts payable that collectively equal a dollar value that meets said dollar value limit of said accounts payable to be accepted and paid.

70. The method of claim 68, wherein said requirements and specifications of the auction comprise a dollar value limit to the discounted payments to be made with respect to successful bids, wherein a successful bid offers a largest percentage discount and results in a discounted payment that together with other successful bids meets said dollar value limit of discounted payments to be made.

71. The method of claim 67, wherein said auction is conducted in an electronic medium comprising the further step of at least one of said Suppliers communicating from a remote location a bid of a percentage discount with respect to an account payable of said Purchaser owing or to become owing to said Supplier for the accelerated payment of said account payable.

72. The method of claim 67, wherein said auction is conducted over a computerized network and said auction comprises the steps of: at least one Supplier inputting a bid, wherein said bid comprises a percentage discount with respect to an account payable of said Purchaser owing or to become owing to said Supplier for the accelerated payment of said account payable at a discount, posting said bid to a server; and said Purchaser inputting an acceptance or rejection of said bid in accordance with the requirements and specifications of the auction.

73. The method of claim 67, wherein the step of transferring payment to said Supplier of said discounted amount comprises the step of said Purchaser transferring said payment to said Supplier through an electronic wire transfer.

74. The method of claim 67, wherein the step of transferring payment to said Supplier of said discounted amount comprises the step of said Purchaser transferring said payment to said Supplier through at least one of the steps of passing the funds through an automated clearing house and electronically transferring funds.

75. The method of claim 67, wherein the step of transferring payment to said Supplier of said discounted amount comprises the step of said Purchaser transferring said payment to said Supplier by delivering a check.

76. The method of claim 67, wherein the step of said Purchaser financing payment to said Supplier of said discounted amount comprises the step of said Purchaser using at least one of existing and self-generated funds.

77. The method of claim 67, wherein the step of said Purchaser financing payment to said Supplier of said discounted amount comprises the step of said Purchaser obtaining a loan.

78. The method of claim 67, wherein the step of said Purchaser financing payment to said Supplier of said discounted amount comprises the step of said Purchaser issuing commercial paper.

79. A computerized auction system for processing and converting at least one account payable into a new obligation over a computerized network, comprising:
a Supplier node used by a Supplier to input bids of percentage discounts with respect to an account payable of a Purchaser owing or to become owing to said Supplier for the accelerated payment of said account payable;
a Purchaser node used by said Purchaser to schedule the Suppliers and the accounts payable that are to be included in an auction and to program the requirements and specifications of a particular auction; and
a server programmed with the requirements and specifications of a particular auction, said server receiving a schedule of Suppliers and accounts payable that are to be included in an auction from said Purchaser node, receiving bids from said Supplier node, comparing said bids to the requirements and specifications of the auction to determine successful or acceptable bids, and transmitting notification of acceptance or rejection of a bid to said Supplier node and said Purchaser node.

80. An auction system as in claim 79, wherein said Supplier node and Purchaser node communicate with each other to provide information regarding an auction.

81. An auction system as in claim 79, wherein said server maintains a database of information regarding a Purchaser's Suppliers.

82. An auction system as in claim 79, wherein said server generates reports regarding the results of an auction and transmits said reports to said Purchaser node.

83. An auction system as in claim 79, wherein said server schedules the discounted payments to be made to said Suppliers that submitted winning bids.

84. A method of converting at least one account payable into a new obligation using a computerized auction system, comprising the steps of:
a Purchaser establishing a computerized auction system over a computerized network including a database of information regarding said Purchaser's Suppliers;
programming a server of said computerized auction system with the requirements and specifications for the auction;
receiving from said Purchaser a list of Suppliers and accounts payable of said Purchaser that said Purchaser wishes to be included in an auction and providing said list to the server;
the server notifying the Suppliers on the list generated by the Purchaser of the auction and of the accounts payable for which the Supplier may enter bids in the auction;
receiving from each Supplier that chooses to participate in said auction a bid, wherein each such bid comprises a percentage discount with respect to an account payable of said Purchaser owing or to become owing to each said Supplier for the accelerated payment of said account payable, each bid being posted to said server;
the server processing the bids entered by Suppliers in accordance with the requirements and specifications of the auction and determining the winning or successful bids under said auction, and advising each Supplier that bid whether its bid was accepted or rejected.

85. The method of claim 84, comprising the further steps of said server preparing a report regarding said auction results and transmitting said results to the Purchaser.

86. The method of claim 85, comprising the further step of said server scheduling the payments to be made to the Suppliers that submitted the winning bids using payment specifications from a database of information regarding a Purchaser's Suppliers.

87. The method of claim 84, comprising the further step of the Purchaser issuing commercial paper to fund its discounted payments to said Suppliers.

88. The method of claim 84, comprising the further step of the Purchaser initiating payment to each Supplier that has performed upon confirming such performance.
